(19) United States
(12) Patent Application Publication
(10) Pub. No.: US 2026/0313708 A1
(43) Pub. Date: Oct. 8, 2026

(54) RANDOM ACCESS

(71) Applicant: Nokia Technologies Oy, Espoo (FI)

(72) Inventor: Stepan Kucera, Munich (DE)

(21) Appl. No.: 19/559,007

(22) Filed: Mar. 6, 2026

(30) Foreign Application Priority Data
Apr. 2, 2025 (EP) 25168136.7

(51) Int. Cl. H04W 74/0833; H04W 68/02

(52) U.S. Cl. CPC H04W 74/0833; H04W 68/02

(57) ABSTRACT

According to an example aspect of the present invention, there is provided an apparatus configured to determine, in a contention-based random access process, that the apparatus does not detect a message in response to a page provided from the apparatus to a correspondent node, determine, in the contention-based random access process, that a second correspondent node provides to the apparatus a same node identity as the correspondent node, and transmit a second page in the contention-based random access process, the second page comprising the node identity.

### CROSS-REFERENCE TO RELATED APPLICATION

This application claims the benefit of EP Application Serial No. 25168136.7 filed on 2 Apr. 2025, which is incorporated herein by reference in its entirety.

### FIELD

The present disclosure relates to wireless random access processes.

### BACKGROUND

A random-access process may be used by devices seeking to access a network, using a set of shared resources. These resources may be timeslots, frequencies, spreading codes or combinations thereof, for example, depending on the communication technology being used. Random access processes may be contention-based, wherein distinct devices choose resources they will use such that they may, by chance, choose the same resources, or the processes may be contention-free wherein the network co-ordinates resource use such that use of the same resource(s) by distinct devices is not possible. When the same resources are used by plural devices in the contention-based approach, a collision is said to occur, which may be resolved using various processes, depending on the communication technology being used.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core and at least one memory storing instructions that, when executed by the at least one processing core, cause the apparatus at least to determine, in a contention-based random access process, that the apparatus does not detect a message in response to a page provided from the apparatus to a correspondent node, determine, in the contention-based random access process, that a second correspondent node provides to the apparatus a same node identity as the correspondent node, and transmit a second page in the contention-based random access process, the second page comprising the node identity.

According to a second aspect of the present disclosure, there is provided an apparatus comprising at least one processing core and at least one memory storing instructions that, when executed by the at least one processing core, cause the apparatus at least to transmit, in a contention-based random access process, a message to a reader as a response to a page, the page comprising a node identity of the apparatus has provided to the reader in the contention-based random access process, receive a second page in the contention-based random access process, the second page comprising the node identity of the apparatus, wherein the second page comprises at least one of: the node identity more than once, or indications of radio resources to be used by the apparatus and another apparatus in responding to the second page.

According to a third aspect of the present disclosure, there is provided a method comprising determining, by an apparatus, in a contention-based random access process, that the apparatus does not detect a message in response to a page provided from the apparatus to a correspondent node, determining, in the contention-based random access process, that a second correspondent node provides to the apparatus a same node identity as the correspondent node, and transmitting a second page in the contention-based random access process, the second page comprising the node identity.

According to a fourth aspect of the present disclosure, there is provided a method, comprising transmitting, by an apparatus, in a contention-based random access process, a message to a reader as a response to a page, the page comprising a node identity of the apparatus has provided to the reader in the contention-based random access process, receiving a second page in the contention-based random access process, the second page comprising the node identity of the apparatus, wherein the second page comprises at least one of: the node identity more than once, or indications of radio resources to be used by the apparatus and another apparatus in responding to the second page.

According to a fifth aspect of the present disclosure, there is provided a non-transitory computer readable medium having stored thereon a set of computer readable instructions that, when executed by at least one processor, cause an apparatus to at least determine, in a contention-based random access process, that the apparatus does not detect a message in response to a page provided from the apparatus to a correspondent node, determine, in the contention-based random access process, that a second correspondent node provides to the apparatus a same node identity as the correspondent node, and transmit a second page in the contention-based random access process, the second page comprising the node identity.

According to a sixth aspect of the present disclosure, there is provided a non-transitory computer readable medium having stored thereon a set of computer readable instructions that, when executed by at least one processor, cause an apparatus to at least transmit, in a contention-based random access process, a message to a reader as a response to a page, the page comprising a node identity of the apparatus has provided to the reader in the contention-based random access process, receive a second page in the contention-based random access process, the second page comprising the node identity of the apparatus, wherein the second page comprises at least one of: the node identity more than once, or indications of radio resources to be used by the apparatus and another apparatus in responding to the second page.

According to a seventh aspect of the present disclosure, there is provided an apparatus, comprising means for determining, by an apparatus, in a contention-based random access process, that the apparatus does not detect a message in response to a page provided from the apparatus to a correspondent node, determining, in the contention-based random access process, that a second correspondent node provides to the apparatus a same node identity as the correspondent node, and transmitting a second page in the contention-based random access process, the second page comprising the node identity.

According to an eighth aspect of the present disclosure, there is provided an apparatus, comprising means for transmitting, by an apparatus, in a contention-based random access process, a message to a reader as a response to a page, the page comprising a node identity of the apparatus has provided to the reader in the contention-based random access process, receiving a second page in the contention-based random access process, the second page comprising the node identity of the apparatus, wherein the second page comprises at least one of: the node identity more than once, or indications of radio resources to be used by the apparatus and another apparatus in responding to the second page.

### BRIEF DESCRIPTION OF THE DRAWINGS

FIG. 1A illustrates an example system in accordance with at least some embodiments of the present invention;

FIG. 1B illustrates an example system in accordance with at least some embodiments of the present invention;

FIG. 1C illustrates an example system in accordance with at least some embodiments of the present invention;

FIG. 2 illustrates an example apparatus capable of supporting at least some embodiments of the present invention;

FIG. 3 illustrates signalling in accordance with at least some embodiments of the present invention, and

FIGS. 4 and 5 are flow graphs of methods in accordance with at least some embodiments of the present invention.

### DETAILED DESCRIPTION

Disclosed herein are methods in contention-based random access processes, wherein collisions between node identities are handled in an efficient manner. In detail, in a situation where at least two nodes respond to an initial message by assuming, by chance, the same node identity, these nodes may be paged using this same identity. By paging the nodes thus, a group may be formed in the random-access process despite only one identity being involved. The nodes using this node identity may, depending on the embodiment and the circumstances, be able to determine whether the second page is meant for them specifically. By paging with the collided node identity, a benefit is obtained in that all nodes in the vicinity need not be included in a new random access process, and handling the node identity collision is more efficient since only the nodes involved will respond to the page with the collided node identity. Re-paging the entire node population would be less efficient and does not solve the underlying problem, as there is no guarantee that all nodes will be able to respond in a subsequent paging session, for example due to poor coverage.

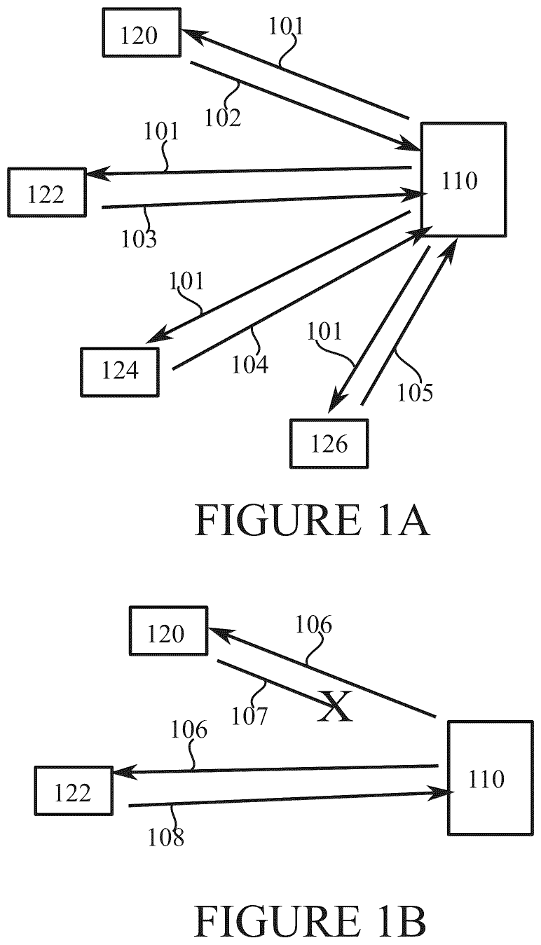

FIG. 1A illustrates an example system in accordance with at least some embodiments of the present invention. Reader 110 is a node configured to initiate random access processes with nodes 120, 122, 124 and 126. The number of nodes in FIG. 1A is an example to which the present disclosure is by no means limited, rather, there may be fewer than four or more than four nodes. Reader 110 comprises a wireless transceiver configured to transmit wireless messages nodes 120, 122, 124 and 126 are configured to receive, enabling bidirectional communication between reader 110 and nodes 120, 122, 124 and 126. Nodes 120, 122, 124 and 126 may be ambient internet of things, IoT, nodes, for example, and reader 110 may have ambient IoT reader functionality.

Reader 110 may thus be an ambient internet of things, IoT, reader. Such a reader may be a standalone node, or a cellular user equipment, UE, with an ambient IoT transceiver comprised therein. In some embodiments, reader 110 may be a cellular base station node, or a distributed unit of a cellular base station, comprising an ambient IoT transceiver and to perform in a role of an ambient IoT, AIoT, reader in addition to its cellular role. Operation of an AIoT reader may be in based on public industry standards as established by the 3^{rd} generation partnership project, 3GPP, for example. These standards define frequency ranges where AIoT communication is to take place, and modulation and coding methods to be employed in AIoT communication.

IT refers to networks of interconnected devices that communicate and exchange data with each other over the internet, or connected with the internet. These devices, ranging from household appliances to industrial machinery, may be embedded with sensors, software, and other technologies that enable them to collect and share information. IoT systems may enhance efficiency, automation, and decision-making by providing real-time data, remote control and monitoring. IoT nodes may be used in transportation, healthcare and smart homes, for example. IoT nodes may comprise wireless tags attached to packages in transit, automated utility meters configured to measure use of electricity, water or gas, or sensor nodes which may form sensor networks. For example, sensor nodes may be configured to measure temperature, air pressure, presence of smoke, vibration or radioactivity, and report their sensor data via the internet. IoT nodes may employ machine-type communications, MTC, and may only occasionally have sensor data to transmit.

In some use cases, IoT could be useful but powering more traditional IoT nodes would be impractical. For example, very large numbers of nodes would require correspondingly large numbers of batteries to be replaced or recharged to maintain these nodes in an operable condition. Yet further, in case the use cases relate to low-value processes, such as package deliveries, providing complex IoT nodes in the system would be too energy-inefficient to be worth the effort. For such use cases, ambient IoT, AIoT, describes simple IoT nodes with more constrained capabilities than the more traditional IoT nodes.

AIoT nodes may be built without including batteries, making re-charging or replacing batteries of AIoT nodes unnecessary. To power their operation, AIoT nodes may be configured to harvest energy from their surroundings, such as from temperature differences via the thermoelectric effect, or from wireless transmissions from which energy may be harvested using a suitable hardware device. Further, photovoltaic cells may be used to harvest energy from electromagnetic radiation in certain frequency ranges. AIoT nodes may have more limited data processing, data communication and data storage capabilities when compared to more traditional IoT nodes which have access to battery power, or a stable power source. AIoT nodes may have either no means to store electrical energy, or they may have a capacitor to store a quantity of harvested electrical energy for subsequent use.

In particular, AIoT nodes 120, 122, 124, 126 may be capable of transmitting data to a reader 110 using a backscatter transceiver, wherein energy for transmission is obtained from a simultaneous signal received from the reader. A backscatter transceiver is a device that enables communication by reflecting existing radio frequency signals rather than generating its own. This technology is particularly useful for ultra-low-power and passive communication systems, such as AIoT nodes. In a backscatter communication link, the backscatter transceiver modulates a reflection of an incident signal to encode data, which can then be decoded by a receiver, such as a receiver of reader 110. This method significantly reduces power consumption in the node compared to a transceiver using battery power in the node. Alternatively to a backscatter transmitter, AIoT nodes 120, 122, 124, 126 may use a transceiver powered from a capacitor filled with charge harvested from a photovoltaic cell, for example. Either way, the transceivers of AIoT nodes 120, 122, 124, 126 are powered using ambient energy harvested from the surroundings of these nodes.

Reader 110 may be powered using a battery, or even a stable power source, such as mains power, for example. As such, reader 110 is capable of more complex data processing than AIoT nodes 120, 122, 124, 126. In particular, reader 110 has an actively powered transceiver, and in case reader 110 is a cellular UE, it may have a cellular transceiver and a separate AIoT transceiver. The AIoT transceiver is capable of powering the backscatter transceivers of nodes 120, 122, 124, 126 in embodiments where these nodes have backscatter transceivers.

In the system of FIG. 1A, reader 110 has broadcast a first message 101, which may be referred to as an Msg0 in a contention-based random access process. The first message may have a scope indication, for example, to restrict the number of nodes which will respond to it. The scope indication may relate to a characteristic the nodes are associated with, for example in a package delivery embodiment, the scope indication may be a criterion expressed concerning a delivery due date of a package to which the respective node is attached to. As another example, the scope indication may specify a sensor type, such as temperature sensor, such that nodes which have sensor data of this type should respond to the first message 101.

By broadcasting it is herein meant, that the first message is not addressed to any node in particular using a node identity. In response, each node 120, 122, 124, 126 which received this first message responds with a second message 102, 103, 104, 105, which may be referred to as an Msg1, the second message comprising a node identity each node randomly or pseudo-randomly chooses. In case a scope indication was present in first message 101, then nodes which don't meet the scope indicated in the scope indication refrain from transmitting second message 102, 103, 104, 105. As the nodes do not coordinate this selection of identity, it is possible that two, or indeed more than two, nodes select the same node identity for inclusion in second message 102, 103, 104, 105. The likelihood of such a node identity collision depends on a bit length of the node identity which is used, and a number of nodes 120, 122, 124, 126 within range of first message 101.

Reader 110 may send messages to individual ones of nodes 120, 122, 124, 126 by addressing the messages using the node identity provided in messages 102, 103, 104, 105. The nodes 120, 122, 124, 126 need only remember the node identity provided in the second message 102, 103, 104, 105 to enable each one to determine, if a subsequent message from reader 110 is meant for it or another one of nodes 120, 122, 124, 126.

FIG. 1B illustrates an example system in accordance with at least some embodiments of the present invention. The messaging of FIG. 1B takes place after that of FIG. 1A, in the same contention-based random access process. Here nodes 120 and 122 have selected, by chance, the same node identity and reported it to reader 110 in messages 102 and 103. In terms of addressability from the reader's point of view, these two nodes are thus difficult to distinguish from each other. Reader 110 delivers a page 106 which comprises the node identity selected by nodes 120 and 122. A page may be referred to as an Msg2. The nodes are configured to respond to a page by delivering their payload to the reader. What the payload is depends on the embodiment, for example in a package delivery scenario the payload may be an identifier of a package the node is attached to. In a sensor network embodiment the payload may be sensor data sensor of the respective node, for example. For example, the sensor data may be a sequence of temperature or pressure values, determined at a fixed time periodicity.

Since the node identity is the same, page 106 is effectively addressed to both nodes 120 and 122. The node identity being different than those selected by nodes 124 and 126, wherefore these nodes will not consider page 106 to be addressed to them. Nodes 120 and 122 respond to page 106 by providing their payload in a third message 107, 108, which may be referred to as a payload message or Msg3. In some embodiments, Msg3, the third message, is not a payload message in the sense of comprising the payload, if payload is delivered in e.g. a separate Msg4. In some cases, Msg3 comprises identifiers and/or control data. In the example of FIG. 1B, payload message 107 from node 120 fails to arrive in reader 110, such that reader 110 does not detect it. There may be different reasons for the apparatus not detecting the payload message. For example, the payload message may be transmitted with too low power for it to be successfully decoded in the presence of noise, the payload message may be transmitted from too far away, the payload message may collide with another wireless datagram in the wireless interface, or the payload message may simply not be sent, for example due to an error or lack of sufficient energy at the transmitter. This failure may be due to different reasons, for example, it may fail due to air interface collision with payload message 108, or if node 120 uses backscatter transmission, for example, it may fail simply due to lack of sufficient energy. Node 120 has no way of knowing that payload message 107 failed to reach its destination as the random access process does not have an acknowledgement mechanism. Both nodes 120, 122 consider themselves to already have delivered their payload after transmissions of Msg3 107 and 108, respectively.

FIG. 1C illustrates an example system in accordance with at least some embodiments of the present invention. The messaging of FIG. 1C takes place after that of FIG. 1B, in the same contention-based random access process. Here reader 110 transmits a second page 109, which comprises the node identity which page 106 comprised, in other words, the node identity that both nodes 120, 122 have randomly or pseudo-randomly selected in this contention-based random access process. In response, nodes 120, 122 re-transmit their payload messages as messages 109, 110. In this example, these transmissions succeed and reader 110 is then in possession of the payload of both nodes 120, 122. Second page 109 may be transmitted using a frequency band defined for ambient Internet of things, IoT, communication in 3rd generation partnership project, 3GPP, specifications of Release 19, for example.

In some embodiments, second page 109 comprises the node identity more than once, for example twice or thrice. A benefit of this is that in case node 122 has not yet transmitted its payload message, it can determine that second page 109 isn't meant for it, as it relates to a node concerning whose payload message reader 110 has encountered a timeout, and node 122 hasn't yet transmitted its payload message. Thus node 122 can decide to only transmit its payload message once, despite receiving two pages which comprise the node identity node 122 has selected for itself. More generally, second page 109 may comprise in addition to the node identity, an indication of node identity collision. The second occurrence of the node identity is an example of the indication of node identity collision. Another example of the indication of node identity collision is a single bit indicator used to indicate either absence or presence of node identity collision.

In some embodiments, second page 109 comprises indications of radio resources to be used by nodes 120, 122 when transmitting their payload messages responsive to the second page 109. For example, the set of resources the nodes may select the resources to use from may be enlarged compared to a set of resources usable when responding to page 106. The larger set of resources reduces a risk, that the nodes choose the same resources, which would cause an air interface collision of the payload messages 110, 111. The resources may be indicated in terms of time, frequency, spreading code of a combination of these, for example. The simplest case is the one where the resource is a time slot. The indicating of resources may be performed also in embodiments where the indication of node identity collision is included in second page 109.

When second page 109 comprises the indication of resources, the indicated radio resources may overlap, at least partly, with the set of resources usable when responding to page 106. On the other hand, the radio resources indicated in second page 109 may have no overlap with the set of resources usable when responding to page 106. The set of resources usable when responding to page 106 may be indicated in first page 106, or they may be a default set of radio resources, needing no explicit indication. When the resources the nodes may select from in responding to second page 109 are significantly greater in number than when responding to page 106, the process approaches a transition from a contention-based to a contention-free random access process, since the probability of a collision in resources is significantly reduced.

In some embodiments, second page 109 is addressed to a specific one of nodes 120 and 122 by including in second page 109 an indication of a time slot used by the specific node, 120 or 122, in providing the second message 102, 103, 104, 105 to reader 110. This enables addressing individual nodes from among a group of nodes which have selected the same node identity in the contention-based random access process, however it requires the nodes to store the timeslot they used in sending the second message 102, 103, 104, 105. The nodes may be configured to select the timeslot to use randomly, wherefore they select randomly, or pseudo-randomly, both the timeslot used to convey the second message, and the node identity included in the second message.

While described herein as being configured to perform transmitting of page 106 and second page 109 in the same contention-based random access process, in other embodiments reader 110 is configured to transmit, in a subsequent contention-based random access process, a further page comprising the node identity established in the original contention-based random access process. These embodiments require the nodes 120, 122, 124, 126 to store the node identity they selected beyond the duration of a single random access process. In these embodiments second page 109 may be provided in the same contention-based random access process as page 106, and then the further page in the subsequent contention-based random access process, or alternatively second page 109 may be omitted from the same contention-based random access process as is used for page 106, and the further page may be provided in the subsequent contention-based random access process thus without providing second page 109. The contents of the further page may be identical to the contents of second page 109.

In some embodiments, second page 109 comprises an indicator indicating a manner in which the correspondent node should select resources for transmitting a reply to the second page. For example, the indication may relate that the nodes 120, 122 should select the resource, such as timeslot, based on a quantity of data they have in their payload, or based on their serial numbers, enabling reader 110 to force the nodes to use resources other than a default resource when responding with their payload messages.

In some embodiments, nodes paged with their node identity may abstain from repeating the whole random access process from the start, but only continue from their last successful action. Thus nodes which have already received one page may continue with (re)-sending their payload message, and nodes which have not yet received a page may proceed directly to their payload message for the first time.

Overall, reader 110 may provide the second page to the failed node(s) either within the current (ongoing) random access process associated with page 106 and referred to via a specific session or paging identifier, or during a subsequent random access process characterized by another session or paging identifier. In paging, it is possible to use core-network request numbers to identify individual requests and the associated paging messages. If a new paging message is received by a node and the “session” or “transaction” identifier is different, the node will know that this paging is comprised in a new random-access process. If the “session” or “transaction” identifier is the same as in an initial paging message, the node knows the original random-access process is still ongoing.

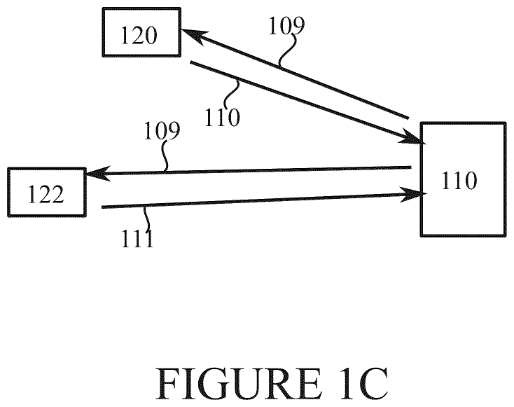

FIG. 2 illustrates an example apparatus capable of supporting at least some embodiments of the present invention. Illustrated is device 200, which may comprise, for example, a reader 110 of FIG. 1A-1C. Device 200 is an apparatus and corresponds primarily to the case where the reader functionality resides in a smartphone. However, in applicable parts, device 220 may also correspond to one of nodes 120, 122, 124, 126 or to the case where the reader resides in a base station or distributed unit of a base station. Comprised in device 200 is processor 210, which may comprise, for example, a single- or multi-core processor wherein a single-core processor comprises one processing core and a multi-core processor comprises more than one processing core. Processor 210 may comprise, in general, a control device. Processor 210 may comprise more than one processor. When processor 210 comprises more than one processor, device 200 may be a distributed device wherein processing of tasks takes place in more than one physical unit. Processor 210 may be a control device. A processing core may comprise, for example, a Cortex-A8 processing core manufactured by ARM Holdings or a Zen processing core designed by Advanced Micro Devices Corporation. A processing core or processor may be, or may comprise, at least one qubit. Processor 210 may comprise at least one Qualcomm Snapdragon and/or Intel Atom processor. Processor 210 may comprise at least one application-specific integrated circuit, ASIC. Processor 210 may comprise at least one field-programmable gate array, FPGA. Processor 210, optionally together with memory and computer instructions, may be means for performing method steps in device 200, such as determining, transmitting, including, receiving and storing. Processor 210 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory (ies) that work together to cause an apparatus, such as an IoT node or reader, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 200 may comprise memory 220. Memory 220 may comprise random-access memory and/or permanent memory. Memory 220 may comprise at least one RAM chip. Memory 220 may be a computer readable medium. Memory 220 may comprise solid-state, magnetic, optical and/or holographic memory, for example. Memory 220 may be at least in part accessible to processor 210. Memory 220 may be at least in part comprised in processor 210. Memory 220 may be means for storing information. Memory 220 may comprise computer instructions that processor 210 is configured to execute. When computer instructions configured to cause processor 210 to perform certain actions are stored in memory 220, and device 200 overall is configured to run under the direction of processor 210 using computer instructions from memory 220, processor 210 and/or its at least one processing core may be considered to be configured to perform said certain actions. Memory 220 may be at least in part external to device 200 but accessible to device 200. Memory 220 may be transitory or non-transitory. The term “non-transitory”, as used herein, is a limitation of the medium itself (that is, tangible, not a signal) as opposed to a limitation on data storage persistency (for example, RAM vs. ROM).

Device 200 may comprise a transmitter 230. Device 200 may comprise a receiver 240. Transmitter 230 and receiver 240 may be configured to transmit and receive, respectively, information in accordance with at least one cellular or non-cellular standard. Transmitter 230 may comprise more than one transmitter. Receiver 240 may comprise more than one receiver. Transmitter 230 and/or receiver 240 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 200 may comprise an ambient IoT transceiver 250. Ambient IoT transceiver 250 may support a suitable IoT or AIoT communication technology, such as, for example, backscatter communication with the IoT nodes 120, 122, 124, 126.

Device 200 may comprise user interface, UI, 260. UI 260 may comprise at least one of a display, a keyboard, a touchscreen, a vibrator arranged to signal to a user by causing device 200 to vibrate, a speaker or a microphone. A user may be able to operate device 200 via UI 260, for example to configure communications with ambient IoT nodes.

Device 200 may comprise or be arranged to accept a user identity module 270. User identity module 270 may comprise, for example, a subscriber identity module, SIM, card installable in device 200. A user identity module 270 may comprise information identifying a subscription of a user of device 200. A user identity module 270 may comprise cryptographic information usable to verify the identity of a user of device 200 and/or to facilitate encryption of communicated information and billing of the user of device 200 for communication effected via device 200. When device 200 corresponds to an ambient IoT node, user identity module 270 is typically absent.

Processor 210 may be furnished with a transmitter arranged to output information from processor 210, via electrical leads internal to device 200, to other devices comprised in device 200. Such a transmitter may comprise a serial bus transmitter arranged to, for example, output information via at least one electrical lead to memory 220 for storage therein. Alternatively to a serial bus, the transmitter may comprise a parallel bus transmitter. Likewise processor 210 may comprise a receiver arranged to receive information in processor 210, via electrical leads internal to device 200, from other devices comprised in device 200. Such a receiver may comprise a serial bus receiver arranged to, for example, receive information via at least one electrical lead from receiver 240 for processing in processor 210. Alternatively to a serial bus, the receiver may comprise a parallel bus receiver.

Device 200 may comprise further devices not illustrated in FIG. 2. For example, where device 200 comprises a smartphone, it may comprise at least one digital camera. Some devices 200 may comprise a back-facing camera and a front-facing camera, wherein the back-facing camera may be intended for digital photography and the front-facing camera for video telephony. Device 200 may comprise a fingerprint sensor arranged to authenticate, at least in part, a user of device 200. In some embodiments, device 200 lacks at least one device described above. For example, some devices 200 lack user identity module 270.

Processor 210, memory 220, transmitter 230, receiver 240, ambient IoT transceiver 250, UI 260 and/or user identity module 270 may be interconnected by electrical leads internal to device 200 in a multitude of different ways. For example, each of the aforementioned devices may be separately connected to a master bus internal to device 200, to allow for the devices to exchange information. However, as the skilled person will appreciate, this is only one example and depending on the embodiment various ways of interconnecting at least two of the aforementioned devices may be selected without departing from the scope of the present invention.

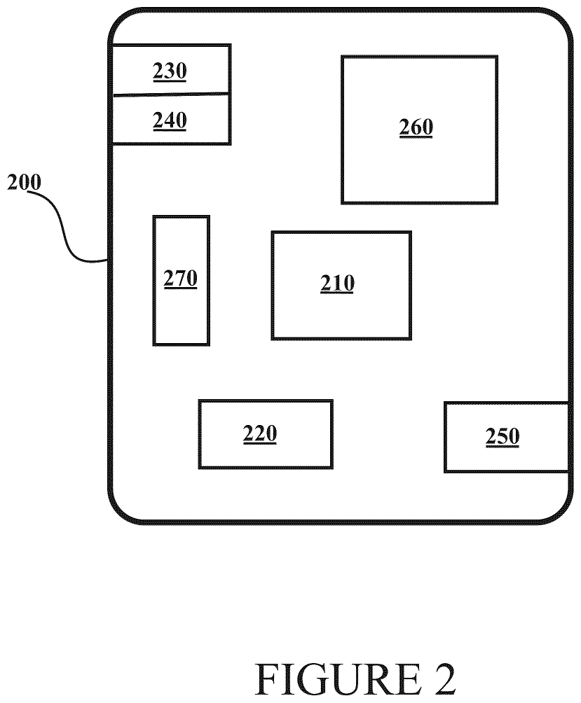

FIG. 3 illustrates signalling in accordance with at least some embodiments of the present invention. On the vertical axes are disposed, on the left, nodes 120 and 122 of FIGS. 1A-1C, and on the right, reader 110 likewise of FIGS. 1A-1C. Time advances from the top toward the bottom.

In phase 310, reader 110 broadcasts the first message 310, corresponding to first message 101 of FIG. 1A. This message may lack addressing in the sense of it comprising an identity of a node, or nodes, to which it is addressed. However, as described herein above, first message 310 may comprise may have a scope indication describing characteristics of nodes in scope of the message, as described herein above.

As first message 310 is broadcasted, nodes 120 and 122 both react to it, of which node 122, in the example of FIG. 3, responds faster. The faster response time may be a result of more energy being available in node 122, for example. Node 122 transmits second message 320 to reader 110, this second message corresponding to second message 103 of FIG. 1A. Second message 320 comprises a node identity node 122 selects for itself as a response to receiving first message 310.

Reader 110 decides to query node 122 for its payload, and to accomplish this it transmits a page 330 to node 122, this page corresponding to page 106 of FIG. 1B. This page is addressed to node 122 using the node identifier node 122 provided to reader 110 in second message 320. Node 122 responds to page 330 by providing its payload message 340, which corresponds to payload message 107 of FIG. 1B. Payload message 340 fails to arrive successfully at reader 110, which reader 110 may detect by observing that a timer set at the transmission of page 330 expires without successful reception of the payload message Msg3.

Node 120 responds to first message 310 by transmitting second message 350, providing to reader 110 the same node identity as was chosen by node 122 and provided to reader in second message 320, creating a collision as to the node identities. Reader 110 is then faced with a situation wherein a payload message from node 122 was expected but not received, and another node provided the same node identity, thereby removing the unambiguous nature of the node identities.

After second message 350 is received in reader 110, reader 110 transmits a second page 360, which comprises the node identity selected by nodes 120 and 122, and an indication of node identity collision. The indication of node identity collision may be a second occurrence of the node identity selected by nodes 120 and 122, as described herein above. The second page thus differs from page 330 in that it comprises the indication of node identity collision. The second occurrence of the node identity is an example of the indication of node identity collision.

In the example of FIG. 3, node 122 and node 120 transmit their payload messages in phases 370 and 380, respectively, as a response to second page 360. Node 122 may infer that a re-transmission is needed as second page 360 comprises the indication of node identity collision, and for node 120 the second page 360 is the first one it receives, wherefore it can react as it would to a regular page comprising the node identity it provided to reader 110, in second message 350, as a response to first message 310.

To enable the resolution of the problem encountered in FIG. 3, node 122 is configured to continue storing its node identity after transmitting its payload message 340. Nodes 120, 122, 124, 126 may each be configured to keep their node identities until the random access process initialized by first message 310 ends. The end of this random-access process may be determined based on expiry of a timer set in response to first message 310, for example. More generally, nodes 120, 122, 124, 126 may be configured to not discard their respective node identities after transmitting its payload message 340. In embodiments where a further page may be sent in a subsequent random-access process, nodes 120, 122, 124, 126 are configured to continue storing their respective node identities even when the random access process initialized by first message 310 ends, such that the nodes are capable of responding to the further page in the subsequent contention-based random access process.

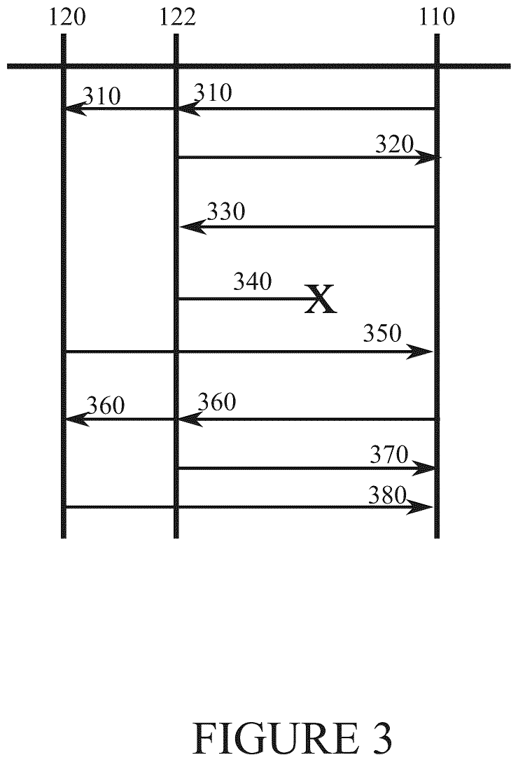

FIG. 4 is a flow graph of a method in accordance with at least some embodiments of the present invention. The phases of the illustrated method may be reader 110, or in a control device configured to control the functioning thereof, when installed therein.

Phase 410 comprises determining, by an apparatus, in a contention-based random access process, that the apparatus does not detect a payload message in response to a page provided from the apparatus to a correspondent node. There may be different reasons for the apparatus not detecting the payload message. For example, the payload message may be transmitted with too low power for it to be successfully decoded in the presence of noise, the payload message may be transmitted from too far away, the payload message may collide with another wireless datagram in the wireless interface, or the payload message may simply not be sent, for example due to an error or lack of sufficient energy at the transmitter. Phase 420 comprises determining, in the contention-based random access process, that a second correspondent node provides to the apparatus a same node identity as the correspondent node. Phase 430 comprises transmitting a second page in the contention-based random access process, the second page comprising the node identity.

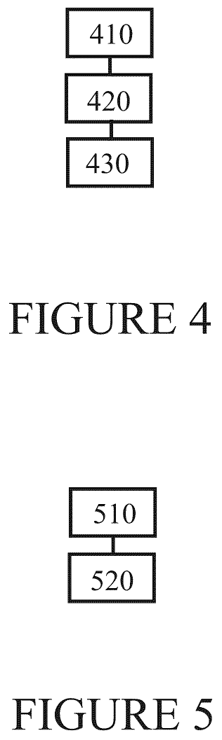

FIG. 5 is a flow graph of a method in accordance with at least some embodiments of the present invention. The phases of the illustrated method may be node 120, 122, or in a control device configured to control the functioning thereof, when installed therein.

Phase 510 comprises transmitting, by an apparatus, in a contention-based random access process, a payload message to a reader as a response to a page, the page comprising a node identity of the apparatus has provided to the reader in the contention-based random access process. Phase 520 comprises receiving a second page in the contention-based random access process, the second page comprising the node identity of the apparatus, wherein the second page comprises at least one of: the node identity more than once, or indications of radio resources to be used by the apparatus and another apparatus in responding to the second page.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

### INDUSTRIAL APPLICABILITY

At least some embodiments of the present invention find industrial application in wireless communication.

### ACRONYMS LIST

3GPP 3^{rd} generation partnership project
AIoT ambient IoT
IoT internet of things
MTC machine-type communications

REFERENCE SIGNS LIST

| | |
|---|---|
| 110 | reader |
| 120, 122, 124, 126 | nodes (e.g. AIoT nodes) |
| 101 | first message |
| 102, 103, 104, 105 | second messages |
| 106 | page |
| 107, 108, 110, 111 | payload messages |
| 109 | second page |
| 200-270 | structure of the device of FIG. 2 |
| 310-380 | signalling in the process of FIG. 3 |
| 410-430 | phases of the method of FIG. 4 |
| 510-520 | phases of the method of FIG. 5 |

1. An apparatus comprising at least one processing core and at least one memory storing instructions that, when executed by the at least one processing core, cause the apparatus at least to:
determine, in a contention-based random access process, that the apparatus does not detect a message in response to a page provided from the apparatus to a correspondent node;
determine, in the contention-based random access process, that a second correspondent node provides to the apparatus a same node identity as the correspondent node, and transmit a second page in the contention-based random access process, the second page comprising the node identity.

2. The apparatus according to claim 1, wherein the second page comprises an indication of node identity collision.

3. The apparatus according to claim 1, further caused to include in the second page indications of radio resources to be used by the correspondent node and the second correspondent node.

4. The apparatus according to claim 3, further caused to perform the transmitting of the second page using a frequency band defined for ambient Internet of things communication in 3rd generation partnership project specifications of Release 19.

5. The apparatus according to claim 3, wherein the indicated radio resources overlap, at least partly, with radio resources indicated earlier in the contention-based random access process.

6. The apparatus according to claim 3, wherein the indicated radio resources have no overlap with radio resources indicated earlier in the contention-based random access process.

7. The apparatus according to claim 3, further caused to indicate in the second page a timeslot used by the correspondent node in providing the node identity to the apparatus.

8. The apparatus according to claim 1, further caused to perform transmitting of the page and the transmitting of the second page in the same contention-based random access process.

9. The apparatus according to claim 1, further caused to transmit, in a subsequent contention-based random access process, a further page comprising the node identity.

10. The apparatus according to claim 1, wherein the second page comprises an indicator indicating a manner in which the correspondent node should select resources for transmitting a reply to the second page.

11. An apparatus comprising at least one processing core and at least one memory storing instructions that, when executed by the at least one processing core, cause the apparatus at least to:
transmit, in a contention-based random access process, a message to a reader as a response to a page, the page comprising a node identity of the apparatus has provided to the reader in the contention-based random access process;
receive a second page in the contention-based random access process, the second page comprising the node identity of the apparatus, wherein
the second page comprises at least one of: the node identity more than once, or indications of radio resources to be used by the apparatus and another apparatus in responding to the second page.

12. The apparatus according to claim 11, wherein the apparatus is powered at least in part by energy the apparatus is configured to harvest from its surroundings.

13. The apparatus according to claim 11, wherein the second page comprises an indicator indicating a manner in which the apparatus should select resources for transmitting a reply to the second page.

14. The apparatus according to claim 11, wherein the second page comprises indications of radio resources to be used by the apparatus in re-sending the message.

15. The apparatus according to claim 14, configured to perform the receiving of the second page using a frequency band defined for ambient Internet of things communication in 3rd generation partnership project specifications of Release 19.

16. The apparatus according to claim 14, wherein the indicated radio resources overlap, at least partly, with radio resources indicated earlier in the contention-based random access process.

17. The apparatus according to claim 14, wherein the indicated radio resources have no overlap with radio resources indicated earlier in the contention-based random access process.

18. The apparatus according to claim 11, configured to select a new node identity responsive to the second page, and to send the new node identity to the reader in a message transmitted in response to the second page.

19. A method comprising:
determining, by an apparatus, in a contention-based random access process, that the apparatus does not detect a message in response to a page provided from the apparatus to a correspondent node;
determining, in the contention-based random access process, that a second correspondent node provides to the apparatus a same node identity as the correspondent node, and
transmitting a second page in the contention-based random access process, the second page comprising the node identity.

20. The method according to claim 19, wherein the second page comprises an indication of node identity collision.
